(19) United States
(12) Patent Application Publication
(10) Pub. No.: US 2024/0317318 A1
(43) Pub. Date: Sep. 26, 2024

(54) VEHICLE BODY REAR SIDE STRUCTURE

(71) Applicant: Honda Motor Co., Ltd., Tokyo (JP)

(72) Inventors: Nozomi MIKAMI, Tokyo (JP); Shungo CHINO, Tokyo (JP); Kodai OMINE, Tokyo (JP); Kyosuke ICHINOHE, Tokyo (JP)

(73) Assignee: Honda Motor Co., Ltd., Tokyo (JP)

(21) Appl. No.: 18/586,515

(22) Filed: Feb. 25, 2024

(30) Foreign Application Priority Data
Mar. 23, 2023 (CN) 202310291286.2

(51) Int. Cl. B62D 25/16

(52) U.S. Cl. CPC B62D 25/16

(57) ABSTRACT

A vehicle body rear side structure is disposed in a vehicle. The vehicle body rear side structure includes: a rear side frame disposed on an outer side of a rear portion of the vehicle in a width direction; a wheel house, located above the rear side frame; and a rear panel disposed to the rear of the wheel house and located on an outer side of the rear side frame. A lower portion of the wheel house is composed of an extension member extending from an outer wall of the rear side frame toward an outer side in the width direction of the vehicle. The rear panel is inclined downward toward the outer side in the width direction of the vehicle and is connected to a lower portion of the extension member.

### CROSS-REFERENCE TO RELATED APPLICATION

This application claims the priority benefit of China application serial no. 202310291286.2, filed on Mar. 23, 2023. The entirety of the above-mentioned patent application is hereby incorporated by reference herein and made a part of this specification.

### BACKGROUND

### Technical Field

The disclosure relates to a vehicle body rear side structure.

### Description of Related Art

In recent years, efforts have been made to provide sustainable transportation systems taking into account disadvantaged groups among transportation participants, such as the elderly, the disabled, and children. In order to achieve this, efforts are being made to develop technologies to improve vehicle body rigidity to further improve transportation safety and convenience.

Patent Literature 1 (Japanese Patent Application Laid-Open No. 2013-203237) describes an anti-collapse pillar, which extends in the width direction of a vehicle from a mounting portion of a sub-frame that supports a rear side frame to strengthen the mounting portion of the sub-frame and reduce the input load from the rear wheels and the sub-frame to prevent the rear side frame from collapsing.

However, in Patent Literature 1, the anti-collapse pillar not only prevents the sub-frame from collapsing, but also prevents the rear side frame from collapsing, which increases the weight of the vehicle and leaves room for improvement.

The disclosure provides a vehicle body rear side structure, which is capable of increasing rigidity to resist the load from the rear wheels and the sub-frame and suppressing collapse of the rear side frame.

### SUMMARY

The vehicle body rear side structure according to the disclosure is disposed in a vehicle. The vehicle body rear side structure includes: a rear side frame, which is disposed on an outer side of a rear portion of the vehicle in a width direction; a wheel house, which is disposed above the rear side frame; and a rear panel, which is disposed to a rear of the wheel house and located on an outer side of the rear side frame. A lower portion of the wheel house is composed of an extension member extending from an outer wall of the rear side frame toward an outer side in the width direction of the vehicle. The rear panel is inclined downward toward the outer side in the width direction of the vehicle and is connected to a lower portion of the extension member.

In this way, the rear panel is disposed below the wheel house and is connected to the lower portion of the extension member extending from the outer wall of the rear side frame toward the outer side in the width direction of the vehicle. Therefore, the rigidity of the rear side frame can be ensured with respect to the load in the width direction of the vehicle input toward the rear side frame, thereby preventing the rear side frame from collapsing. Specifically, the load input to the rear side frame may be effectively transmitted to the rear panel and the wheel house via the extension member, thereby ensuring the rigidity of the rear side frame.

In order to make the above-mentioned features and advantages of the disclosure comprehensible, embodiments accompanied with drawings are described in detail as follows.

### BRIEF DESCRIPTION OF THE DRAWINGS

FIG. 1 is a schematic diagram of a vehicle body rear side structure disposed in a vehicle according to an embodiment of the disclosure.

FIG. 2 is a schematic diagram of the vehicle body rear side structure in FIG. 1 viewed from another angle.

FIG. 3 is a schematic front view of the vehicle body rear side structure of FIG. 1 viewed from the rear of the vehicle.

FIG. 4 is a partially enlarged schematic view of a vehicle body rear side structure disposed in a vehicle according to an embodiment of the disclosure.

FIG. 5 is a schematic diagram of a load transmission path in the vehicle body rear side structure of FIG. 4.

FIG. 6 is a bottom view of a vehicle body rear side structure disposed in a vehicle according to an embodiment of the disclosure.

FIG. 7 is a schematic front view of a vehicle body rear side structure disposed in a vehicle according to an embodiment of the disclosure.

FIG. 8 is a schematic cross-sectional view of the vehicle body rear side structure in FIG. 7.

FIG. 9 is a bottom view of a vehicle body rear side structure disposed in a vehicle according to another embodiment of the disclosure.

FIG. 10 is a schematic front view of the vehicle body rear side structure of FIG. 5 viewed from the rear of the vehicle.

FIG. 11 is a schematic front view of the vehicle body rear side structure of FIG. 5 viewed from the front of the vehicle.

### DESCRIPTION OF THE EMBODIMENTS

In an embodiment of the disclosure, the rear panel has a front end joint portion. A front end of the front end joint portion is joined to the extension member. The front end joint portion is joined to a wall surface of the extension member from above to below the vehicle.

In this way, by joining the front end joint portion of the rear panel to the wall surface of the extension member, the load input from the rear side frame to the extension member can be transmitted to the rear panel. Therefore, the deformation of the extension member can be suppressed and the load can be effectively transmitted to the rear panel, thereby suppressing the deformation of the rear side frame. In an embodiment of the disclosure, the lower portion of the extension member is composed of a connection surface extending from a lower end portion of the wall surface toward a rear of the vehicle. An outer end portion of the rear panel in the width direction of the vehicle is joined to the connection surface.

In this way, the outer end portion of the rear panel in the width direction of the vehicle is joined to the connection surface extending from the lower end portion of the wall surface toward the rear of the vehicle. Therefore, the load input from the rear side frame to the extension member can be efficiently transmitted to the rear panel, thereby preventing the rear side frame from collapsing.

In an embodiment of the disclosure, the vehicle body rear side structure further includes: a sub-frame, which is disposed below the rear side frame; and a stay, which is installed on a lower wall of the rear side frame. The stay connects the sub-frame and the connection surface.

In this way, by disposing the sub-frame below the rear side frame and the stay connecting the rear side frame to the connection surface, the load input from the sub-frame can be directly transmitted to the extension member, so as to prevent the sub-frame and the rear side frame from collapsing. In addition, since the stay is fixed to the connection surface, the distance between the stay and the sub-frame in the height direction can be shortened, thereby improving the transmission efficiency of the load.

In an embodiment of the disclosure, at least a portion of the rear panel and the extension member extends below the lower wall of the rear side frame.

In this way, since the at least a portion of the rear panel and the extension member extends to below the lower wall of the rear side frame, the load in the width direction of the vehicle input to the rear side frame can be efficiently transmitted to the extension member. Moreover, since the extension member and the rear panel can be brought closer to the sub-frame, the transmission efficiency of the load from the sub-frame can be improved.

In an embodiment of the disclosure, the wheel house includes: a side wall, which is located on an inner side in the width direction of the vehicle; a rear wall, which extends from a rear end of the side wall to the outer side in the width direction of the vehicle; and a ridge line, which is disposed between the side wall and the rear wall. The extension member extends to a position where a flange joined to the outer wall of the rear side frame and the ridge line are aligned in an up-down direction of the vehicle.

In this way, since the extension member is joined to the ridge line of the wheel house, the load in the width direction of the vehicle input from the rear side frame to the extension member can be efficiently transmitted to the wheel house via the ridge line, thereby preventing the rear side frame from collapsing.

In an embodiment of the disclosure, the vehicle body rear side structure further includes a floor cross member, which is disposed on an inner side of the rear side frame in the width direction of the vehicle. The extension member extends from a position aligned with the floor cross member in the width direction of the vehicle toward the outer side in the width direction of the vehicle.

In this way, by disposing the extension member and the floor cross member in an aligned position, the load in the width direction of the vehicle input to the rear side frame can be efficiently transmitted to the floor cross member and the extension member, thereby preventing the rear side frame from collapsing.

In an embodiment of the disclosure, the wall surface of the extension member includes a curved portion, which protrudes in a front-rear direction of the vehicle and extends in the width direction of the vehicle. The curved portion is disposed so as to be inclined from below the inner side in the width direction of the vehicle toward above the outer side in the width direction of the vehicle.

In this way, by disposing the wall surface of the extension member with the curved portion that is inclined from below the inner side in the width direction of the vehicle toward above the outer side in the width direction of the vehicle, the load input from the rear side frame and the sub-frame can be transmitted to the wheel house via the curved portion (that is, the wall surface of the extension member), thereby preventing the rear side frame and the sub-frame from collapsing.

In an embodiment of the disclosure, the front end joint portion intersects the curved portion when viewed from the front or rear of the vehicle.

In this way, by intersecting the curved portion and the front end joint portion, the load input to the wall surface of the extension member can be transmitted to the front end joint portion. Therefore, the deformation of the wall surface of the curved portion can be suppressed by the rear panel, and the load from the rear side frame can be efficiently transmitted to the wheel house and the rear panel via the extension member.

The vehicle body rear side structure of the disclosure has at least the following technical effects.

The rear panel is disposed below the wheel house and is connected to the lower portion of the extension member extending from the outer wall of the rear side frame toward the outer side in the width direction of the vehicle. Therefore, the rigidity of the rear side frame can be ensured with respect to the load in the width direction of the vehicle input toward the rear side frame, thereby preventing the rear side frame from collapsing. Specifically, the load input to the rear side frame may be effectively transmitted to the rear panel and the wheel house via the extension member, thereby ensuring the rigidity of the rear side frame.

By joining the front end joint portion of the rear panel to the wall surface of the extension member, the load input from the rear side frame to the extension member can be transmitted to the rear panel. Therefore, the deformation of the extension member can be suppressed and the load can be effectively transmitted to the rear panel, thereby suppressing the deformation of the rear side frame.

The outer end portion of the rear panel in the width direction of the vehicle is joined to the connection surface extending from the lower end portion of the wall surface toward the rear of the vehicle. Therefore, the load input from the rear side frame to the extension member can be efficiently transmitted to the rear panel, thereby preventing the rear side frame from collapsing.

By disposing the sub-frame below the rear side frame and the stay connecting the rear side frame to the connection surface, the load input from the sub-frame can be directly transmitted to the extension member, so as to prevent the sub-frame and the rear side frame from collapsing. In addition, since the stay is fixed to the connection surface, the distance between the stay and the sub-frame in the height direction can be shortened, thereby improving the transmission efficiency of the load.

Since at least a portion of the rear panel and the extension member extends to below the lower wall of the rear side frame, the load in the width direction of the vehicle input to the rear side frame can be efficiently transmitted to the extension member. Moreover, since the extension member and the rear panel can be brought closer to the sub-frame, the transmission efficiency of the load from the sub-frame can be improved.

Since the extension member is joined to the ridge line of the wheel house, the load in the width direction of the vehicle input from the rear side frame to the extension member can be efficiently transmitted to the wheel house via the ridge line, thereby preventing the rear side frame from collapsing.

By disposing the extension member and the floor cross member in an aligned position, the load in the width direction of the vehicle input to the rear side frame can be efficiently transmitted to the floor cross member and the extension member, thereby preventing the rear side frame from collapsing.

By disposing the wall surface of the extension member with the curved portion that is inclined from below the inner side in the width direction of the vehicle toward above the outer side in the width direction of the vehicle, the load input from the rear side frame and the sub-frame can be transmitted to the wheel house via the curved portion (that is, the wall surface of the extension member), thereby preventing the rear side frame and the sub-frame from collapsing.

By intersecting the curved portion and the front end joint portion, the load input to the wall surface of the extension member can be transmitted to the front end joint portion. Therefore, the deformation of the wall surface of the curved portion can be suppressed by the rear panel, and the load from the rear side frame can be efficiently transmitted to the wheel house and the rear panel via the extension member.

Hereinafter, embodiments of the disclosure will be described based on the drawings. It should be noted that in each of the embodiments described below, the same reference numerals are assigned to common parts, and repeated descriptions will be omitted. Hereinafter, embodiments of the disclosure will be described with reference to the drawings.

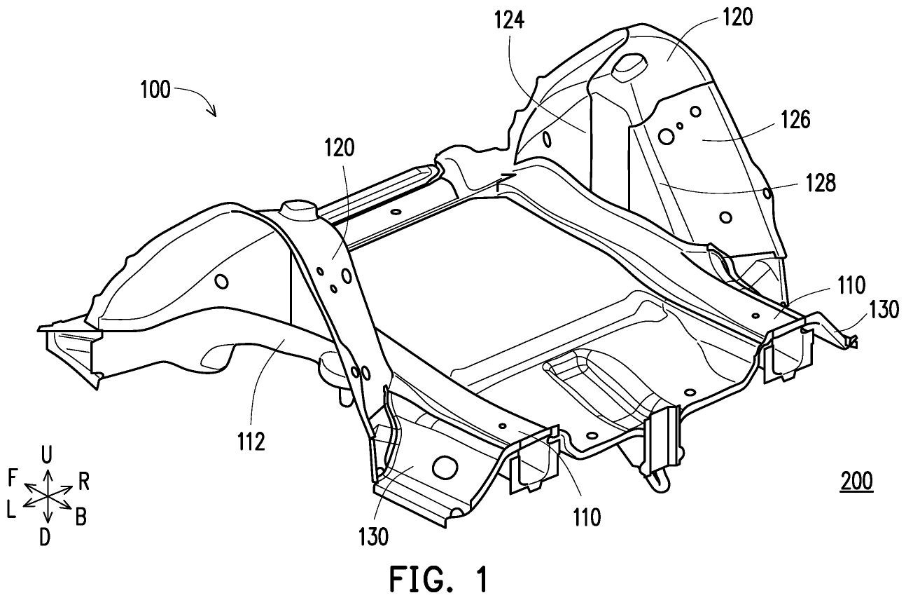

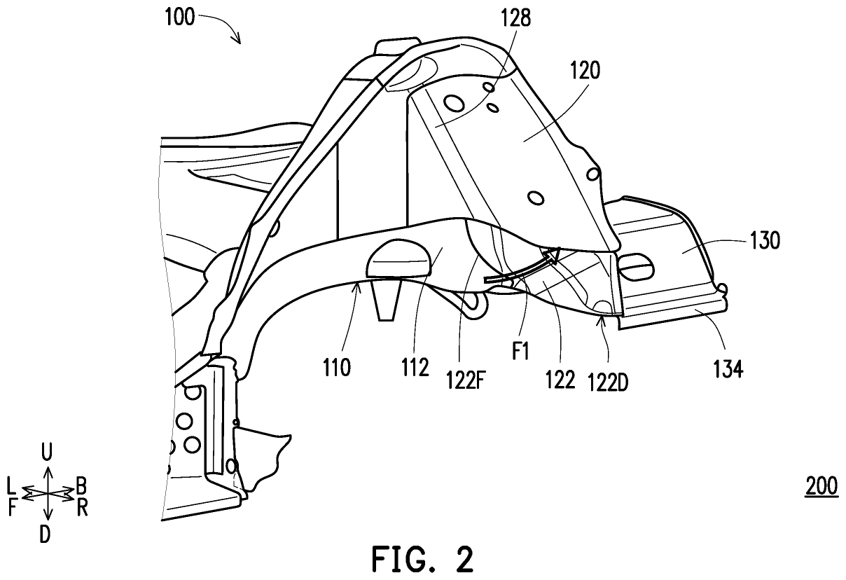

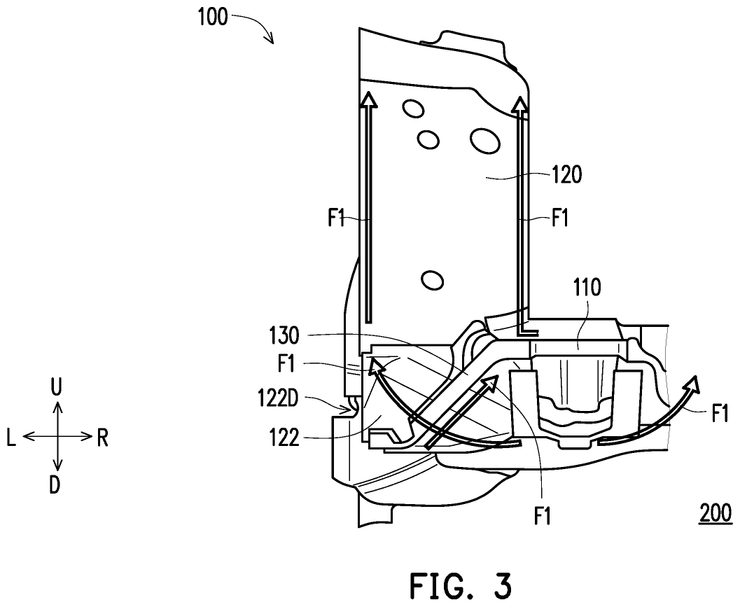

FIG. 1 is a schematic diagram of a vehicle body rear side structure disposed in a vehicle according to an embodiment of the disclosure. FIG. 2 is a schematic diagram of the vehicle body rear side structure in FIG. 1 viewed from another angle. FIG. 3 is a schematic front view of the vehicle body rear side structure of FIG. 1 viewed from the rear of the vehicle. In FIGS. 1 to 3, the coordinate system of front F, rear B, left L, right R, above U and below D of a vehicle 200 is indicated.

Please refer to FIGS. 1 to 3 at the same time. A vehicle body rear side structure 100 is disposed in the vehicle 200. The vehicle body rear side structure 100 includes: a rear side frame 110, which is disposed on an outer side of a rear portion of the vehicle 200 in a width direction L-R; a wheel house 120, which is disposed above U of the rear side frame 110; and a rear panel 130, which is disposed to the rear B of the wheel house 120 and located on an outer side of the rear side frame 110. As shown in FIG. 2, a lower portion of the wheel house 120 is composed of an extension member 122 extending from an outer wall 112 of the rear side frame 110 toward an outer side in the width direction L-R of the vehicle 200. The rear panel 130 is inclined toward below D toward the outer side in the width direction L-R of the vehicle 200 and is connected to a lower portion 122D of the extension member 122.

In this way, the rear panel 130 is disposed below the wheel house 120. The rear panel 130 is connected to the lower portion 122D of the extension member 122 extending from the outer wall 112 of the rear side frame 110 toward the outer side in the width direction L-R of the vehicle 200. Thus, a load F1 can ensure the rigidity of the rear side frame 110 and prevent the rear side frame 110 from collapsing. Specifically, as shown in FIGS. 2 and 3, the load F1 input to the rear side frame 110 can be effectively transmitted to the rear panel 130 and the wheel house 120 via the extension member 122, thereby ensuring the rigidity of the rear side frame 110.

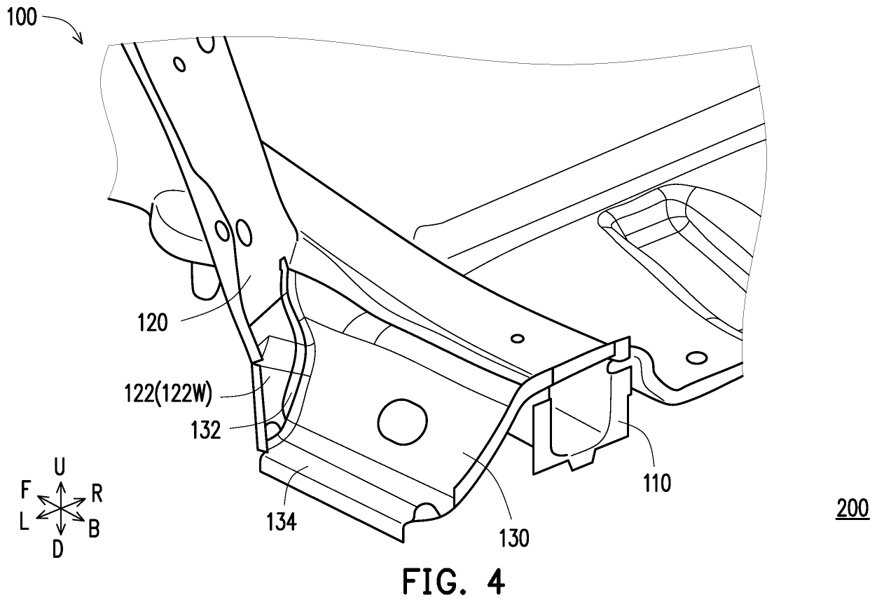

FIG. 4 is a partially enlarged schematic view of a vehicle body rear side structure disposed in a vehicle according to an embodiment of the disclosure. Referring to FIG. 4, the rear panel 130 has a front end joint portion 132. A front end of the front end joint portion 132 is joined to the extension member 122. The front end joint portion 132 is joined to a wall surface 122W of the extension member 122 from above U to below D the vehicle 200.

In this way, by joining the front end joint portion 132 of the rear panel 130 to the wall surface 122W of the extension member 122 (for example, by welding), the load input from the rear side frame 110 to the extension member 122 can be transmitted to the rear panel 130. Therefore, the deformation of the extension member 122 can be suppressed, and the load can be effectively transmitted to the rear panel 130, thereby suppressing the deformation of the rear side frame 110.

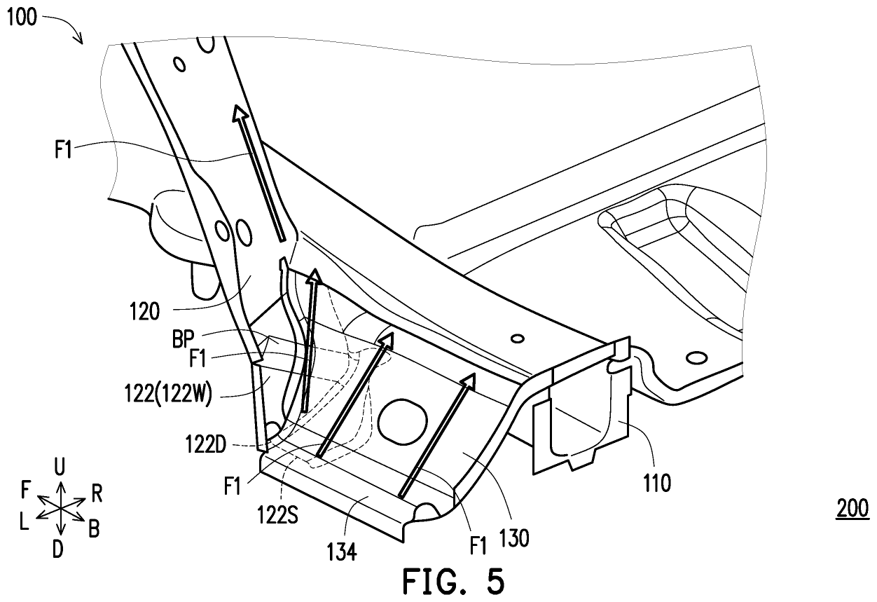

FIG. 5 is a schematic diagram of a load transmission path in the vehicle body rear side structure of FIG. 4. Referring to FIG. 5, the lower portion 122D of the extension member 122 is composed of a connection surface 122S extending from a lower end portion of the wall surface 122W toward the rear B of the vehicle 200. An outer end portion 134 of the rear panel 130 in the width direction L-R of the vehicle 200 is joined to the connection surface 122S. In FIG. 5, the lower portion 122D of the extension member 122 and the connection surface 122S hidden by the rear panel 130 are shown in dotted lines.

In this way, the outer end portion 134 of the rear panel 130 in the width direction L-R of the vehicle 200 is joined to the connection surface 122S extending from the lower end portion of the wall surface 122W toward the rear B of the vehicle 200. Therefore, the load F1 input from the rear side frame 110 to the extension member 122 can be efficiently transmitted to the rear panel 130, thereby preventing the rear side frame 110 from collapsing. In FIG. 5, the load F1 is transmitted via the rear side frame 110 (outward), the wall surface 122W, the connection surface 122S, the rear panel 130 and the wheel house 120.

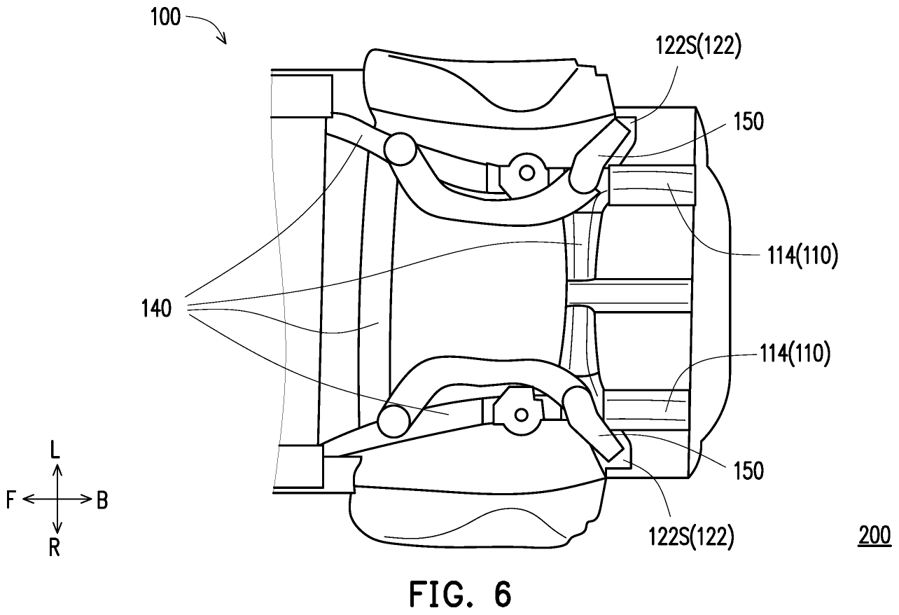

FIG. 6 is a bottom view of a vehicle body rear side structure disposed in a vehicle according to an embodiment of the disclosure. The direction perpendicular to the paper surface in FIG. 6 is an up-down direction U-D. Referring to FIG. 6, the vehicle body rear side structure 100 further includes: a sub-frame 140, which is disposed below D the rear side frame 110; and a stay 150, which is installed on a lower wall 114 of the rear side frame 110. The stay 150 connects the sub-frame 140 and the connection surface 122S. The sub-frame 140 is, for example, a well-shaped support element.

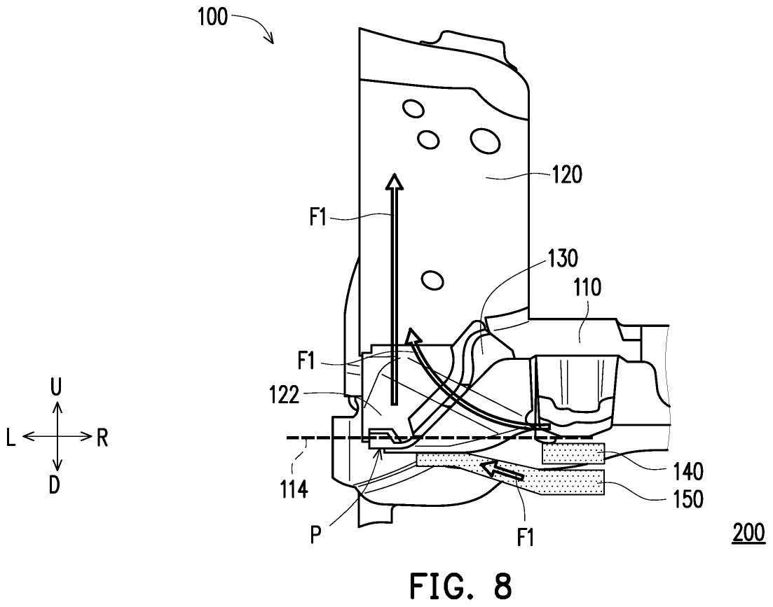

In this way, by disposing the sub-frame 140 below D the rear side frame 110 and the stay 150 connecting the rear side frame 110 and the connection surface 122S, the load input from the sub-frame 140 can be directly transmitted to the extension member 122, so as to prevent the sub-frame 140 and the rear side frame 110 from collapsing. In addition, since the stay 150 is fixed to the connection surface 122S, the distance between the stay 150 and the sub-frame 140 in a height direction U-D can be shortened (referring to FIG. 8 later), thereby improving the transmission efficiency of the load F1.

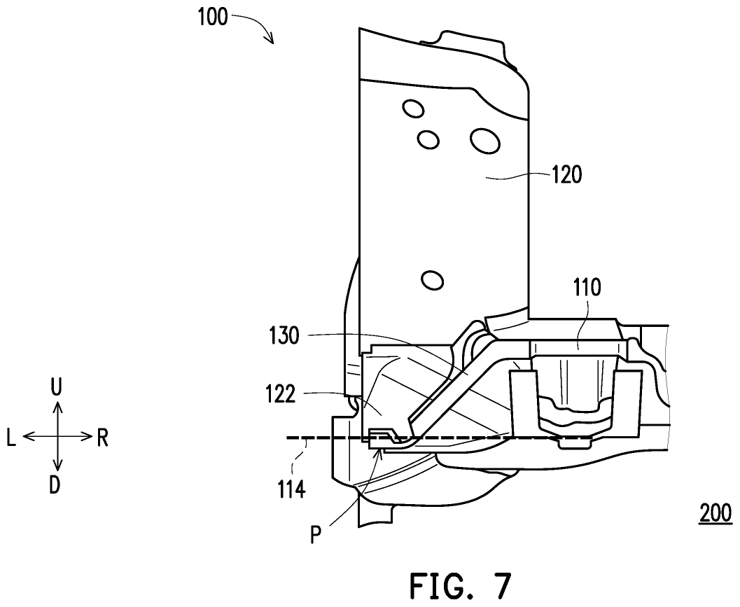

FIG. 7 is a schematic front view of a vehicle body rear side structure disposed in a vehicle according to an embodiment of the disclosure. FIG. 8 is a schematic cross-sectional view of the vehicle body rear side structure in FIG. 7. In FIGS. 7 and 8, the position of the lower wall 114 in the up-down direction UD is indicated by a dotted line. In FIG. 8, the transmission path of the load F1 is shown. Please refer to FIGS. 7 and 8 at the same time. At least a portion P of the rear panel 130 and the extension member 122 extends to below D the lower wall 114 of the rear side frame 110.

In this way, since the at least a portion P of the rear panel 130 and the extension member 122 extends to below D the lower wall 114 of the rear side frame 110, the load F1 in the width direction L-R of the vehicle 200 input to the rear side frame 110 can be efficiently transmitted to the extension member 122. Moreover, since the extension member 122 and the rear panel 130 can be brought closer to the sub-frame 140, the transmission efficiency of the load F1 from the sub-frame 140 can be improved. In FIG. 8, the sub-frame 140 and the stay 150 are shown. It can be seen from FIG. 8 that the distance between the stay 150 and the sub-frame 140 in the height direction U-D is shortened, thereby improving the transmission efficiency of the load F1. The load F1 from the rear side frame 110, the sub-frame 140 and the stay 150 may be transmitted toward the wheel house 120, thereby preventing the rear side frame 110 from collapsing.

Referring to FIGS. 1 and 2 again, the wheel house 120 may include: a side wall 124, which is located on an inner side in the width direction L-R of the vehicle 200; a rear wall 126, which extends from a rear end of the side wall 124 toward the outer side in the width direction L-R of the vehicle 200; and a ridge line 128, which is disposed between the side wall 124 and the rear wall 126. As shown in FIG. 2, the extension member 122 extends to a position where a flange 122F joined to the outer wall 112 of the rear side frame 110 and the ridge line 128 are aligned in the up-down direction U-D of the vehicle 200.

In this way, since the extension member 122 is joined to the ridge line 128 of the wheel house 120, the load F1 in the width direction L-R of the vehicle 200 input from the rear side frame 110 to the extension member 122 can be efficiently transmitted to the wheel house 120 via the ridge line 128, thereby preventing the rear side frame 110 from collapsing.

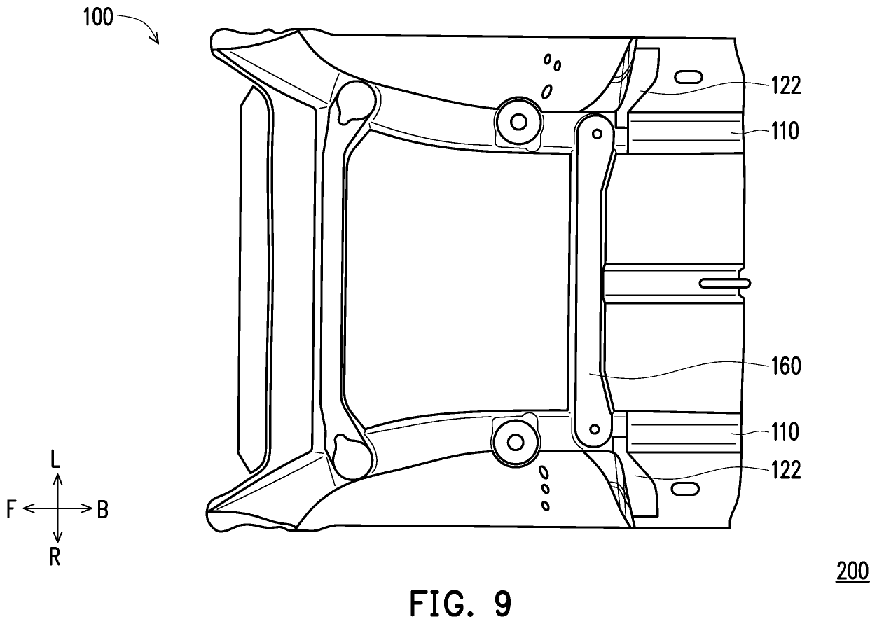

FIG. 9 is a bottom view of a vehicle body rear side structure disposed in a vehicle according to another embodiment of the disclosure. Referring to FIG. 9, the vehicle body rear side structure 100 may further include a floor cross member 160, which is disposed on an inner side of the rear side frame 110 in the width direction L-R of the vehicle 200. The extension member 122 extends toward the outer side in the width direction L-R of the vehicle 200 from a position aligned with the floor cross member 160 in the width direction L-R of the vehicle 200.

In this way, by disposing the extension member 122 and the floor cross member 160 in an aligned position, the load in the width direction L-R of the vehicle 200 input to the rear side frame 110 can be efficiently transmitted to the floor cross member 160 and the extension member 122, thereby preventing the rear side frame 110 from collapsing.

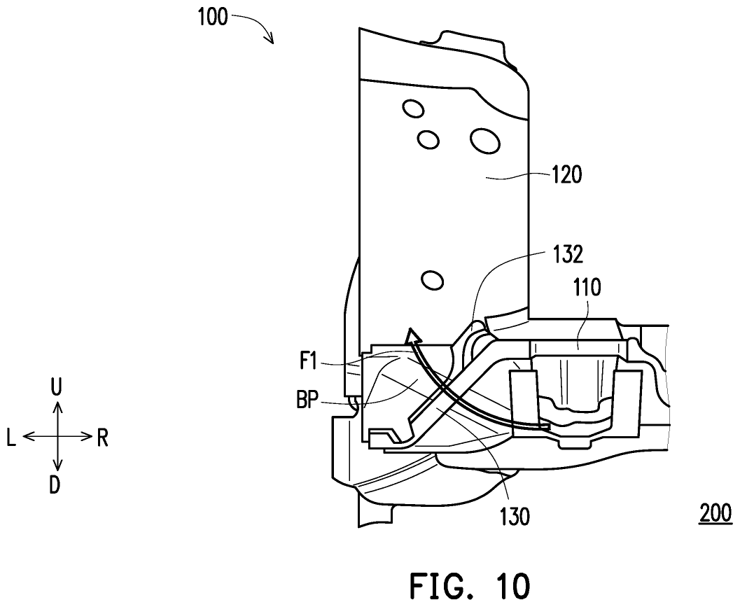

FIG. 10 is a schematic front view of the vehicle body rear side structure of FIG. 5 viewed from the rear of the vehicle. Please refer to FIGS. 5 and 10 at the same time. The wall surface 122W of the extension member 122 includes a curved portion BP, which protrudes in a front-rear direction F-B of the vehicle 200 and extends in the width direction L-R of the vehicle 200. The curved portion BP is disposed so as to be inclined from below D the inner side in the width direction L-R of the vehicle 200 toward above U the outer side in the width direction L-R of the vehicle 200.

In this way, by disposing the wall surface 122W of the extension member 122 with the curved portion BP that is inclined from below D the inner side in the width direction L-R of the vehicle 200 toward above U the outer side in the width direction L-R of the vehicle 200, the load F1 input from the rear side frame 110 and the sub-frame 140 can be transmitted to the wheel house 120 via the curved portion BP (that is, the wall surface 122W of the extension member 122), thereby preventing the rear side frame 110 and the sub-frame 140 from collapsing. In addition, as shown in FIG. 5, the curved portion BP may be supported by the rear panel 130, thereby avoiding breakage of the curved portion BP.

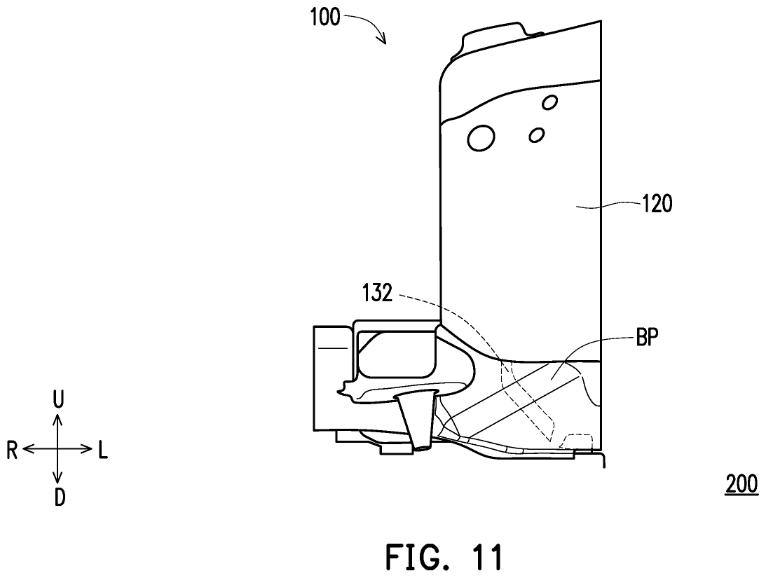

FIG. 11 is a schematic front view of the vehicle body rear side structure of FIG. 5 viewed from the front of the vehicle. Please refer to FIGS. 10 and 11 at the same time. When viewed from the front F or the rear B of the vehicle 200, the front end joint portion 132 intersects the curved portion BP.

In this way, by intersecting the curved portion BP and the front end joint portion 132, the load F1 input to the wall surface 122W of the extension member 122 can be transmitted to the front end joint portion 132. Therefore, the deformation of the wall surface 122W of the curved portion BP can be suppressed by the rear panel 130, and the load F1 from the rear side frame 110 can be efficiently transmitted to the wheel house 120 and the rear panel 130 via the extension member 122.

Based on the above, the vehicle body rear side structure of the disclosure has at least the following technical effects.

The rear panel is disposed below the wheel house and is connected to the lower portion of the extension member extending from the outer wall of the rear side frame toward the outer side in the width direction of the vehicle. Therefore, the rigidity of the rear side frame can be ensured with respect to the load in the width direction of the vehicle input toward the rear side frame, thereby preventing the rear side frame from collapsing. Specifically, the load input to the rear side frame may be effectively transmitted to the rear panel and the wheel house via the extension member, thereby ensuring the rigidity of the rear side frame.

By joining the front end joint portion of the rear panel to the wall surface of the extension member, the load input from the rear side frame to the extension member can be transmitted to the rear panel. Therefore, the deformation of the extension member can be suppressed and the load can be effectively transmitted to the rear panel, thereby suppressing the deformation of the rear side frame.

The outer end portion of the rear panel in the width direction of the vehicle is joined to the connection surface extending from the lower end portion of the wall surface toward the rear of the vehicle. Therefore, the load input from the rear side frame to the extension member can be efficiently transmitted to the rear panel, thereby preventing the rear side frame from collapsing.

By disposing the sub-frame below the rear side frame and the stay connecting the rear side frame to the connection surface, the load input from the sub-frame can be directly transmitted to the extension member, so as to prevent the sub-frame and the rear side frame from collapsing. In addition, since the stay is fixed to the connection surface, the distance between the stay and the sub-frame in the height direction can be shortened, thereby improving the transmission efficiency of the load.

Since at least a portion of the rear panel and the extension member extends to below the lower wall of the rear side frame, the load in the width direction of the vehicle input to the rear side frame can be efficiently transmitted to the extension member. Moreover, since the extension member and the rear panel can be brought closer to the sub-frame, the transmission efficiency of the load from the sub-frame can be improved.

Since the extension member is joined to the ridge line of the wheel house, the load in the width direction of the vehicle input from the rear side frame to the extension member can be efficiently transmitted to the wheel house via the ridge line, thereby preventing the rear side frame from collapsing.

By disposing the extension member and the floor cross member in an aligned position, the load in the width direction of the vehicle input to the rear side frame can be efficiently transmitted to the floor cross member and the extension member, thereby preventing the rear side frame from collapsing.

By disposing the wall surface of the extension member with the curved portion that is inclined from below the inner side in the width direction of the vehicle toward above the outer side in the width direction of the vehicle, the load input from the rear side frame and the sub-frame can be transmitted to the wheel house via the curved portion (that is, the wall surface of the extension member), thereby preventing the rear side frame and the sub-frame from collapsing.

By intersecting the curved portion and the front end joint portion, the load input to the wall surface of the extension member can be transmitted to the front end joint portion. Therefore, the deformation of the wall surface of the curved portion can be suppressed by the rear panel, and the load from the rear side frame can be efficiently transmitted to the wheel house and the rear panel via the extension member.

Finally, it should be noted that the above embodiments are only used to illustrate the technical solutions of the disclosure, but not to limit the technical solutions of the disclosure. Although the disclosure has been described in detail with reference to the foregoing embodiments, those of ordinary skill in the art should understand that the technical solutions described in the foregoing embodiments may still be modified, or some or all of the technical features thereof may be equivalently replaced. However, these modifications or substitutions do not make the essence of the corresponding technical solutions deviate from the scope of the technical solutions of the embodiments of the disclosure.

What is claimed is:

1. A vehicle body rear side structure, disposed in a vehicle, the vehicle body rear side structure comprising:
a rear side frame, disposed on an outer side of a rear portion of the vehicle in a width direction;
a wheel house, disposed above the rear side frame; and
a rear panel, disposed to a rear of the wheel house and located on an outer side of the rear side frame,
wherein a lower portion of the wheel house is composed of an extension member extending from an outer wall of the rear side frame toward an outer side in the width direction of the vehicle, and
the rear panel is inclined downward toward the outer side in the width direction of the vehicle and is connected to a lower portion of the extension member.

2. The vehicle body rear side structure according to claim 1, wherein
the rear panel has a front end joint portion,
a front end of the front end joint portion is joined to the extension member, and
the front end joint portion is joined to a wall surface of the extension member from above to below the vehicle.

3. The vehicle body rear side structure according to claim 2, wherein
the lower portion of the extension member is composed of a connection surface extending from an lower end portion of the wall surface toward a rear of the vehicle, and
an outer end portion of the rear panel in the width direction of the vehicle is joined to the connection surface.

4. The vehicle body rear side structure according to claim 3, further comprising:
a sub-frame, disposed below the rear side frame; and
a stay, installed on a lower wall of the rear side frame,
wherein the stay connects the sub-frame and the connection surface.

5. The vehicle body rear side structure according to claim 4, wherein
at least a portion of the extension panel and the extension member extends below the lower wall of the rear side frame.

6. The vehicle body rear side structure according to claim 1, wherein
the wheel house comprises
a side wall, which is located on an inner side in the width direction of the vehicle,
a rear wall, which extends from a rear end of the side wall toward the outer side in the width direction of the vehicle, and
a ridge line, which is disposed between the side wall and the rear wall,
wherein, the extension member extends to a position where a flange joined to the outer wall of the rear side frame and the ridge line are aligned in an up-down direction of the vehicle.

7. The vehicle body rear side structure according to claim 1, further comprising:
a floor cross member, disposed on an inner side of the rear side frame in the width direction of the vehicle,
wherein the extension member extends from a position aligned with the floor cross member in the width direction of the vehicle toward the outer side in the width direction of the vehicle.

8. The vehicle body rear side structure according to claim 2, wherein
the wall surface of the extension member comprises a curved portion, which protrudes in a front-rear direction of the vehicle and extends in the width direction of the vehicle, and
the curved portion is disposed so as to be inclined from below an inner side in the width direction of the vehicle toward above the outer side in the width direction of the vehicle.

9. The vehicle body rear side structure according to claim 8, wherein
the front end joint portion intersects the curved portion when viewed from a front or rear of the vehicle.
